(19) United States
(12) Patent Application Publication
(10) Pub. No.: US 2011/0083756 A1
(43) Pub. Date: Apr. 14, 2011

(54) COMPRESSED GAS SAFETY DISCHARGE SYSTEM

(75) Inventors: Kiho Hwang, Yongin (KR); Hyungki Kim, Seoul (KR); Sanghyun Kim, Yongin (KR); Hoonhui Lee, Seoul (KR); Youngmin Choi, Yongin (KR); Gyujin Jang, Hwaseong (KR)

(73) Assignee: Hyundai Motor Company, Seoul (KR)

(21) Appl. No.: 12/859,432

(22) Filed: Aug. 19, 2010

(30) Foreign Application Priority Data
Oct. 8, 2009 (KR) 10-2009-0095511

(51) Int. Cl. F16K 31/12

(52) U.S. Cl. 137/488

(57) ABSTRACT

The present invention provides a compressed gas safety discharge system preventing a pressure vessel from breaking and exploding by appropriately and timely operating a pressure relief device, conditions of a fire, such as when a fire occurs around the pressure vessel far from the pressure relief device as well as close to the pressure relief device.

### CROSS-REFERENCE TO RELATED APPLICATIONS

The present application claims under 35 U.S.C. §119(a) priority to Korean Patent Application Number 10-2009-0095511 filed Oct. 8, 2009, the entire contents of which application is incorporated herein for all purposes by this reference.

### BACKGROUND OF THE INVENTION

1. Field of the Invention

The present invention relates, in general, to a technology for automatically discharging compressed gas in a pressure vessel that stores high-pressure gas and prevents the pressure vessel from breaking and exploding when the pressure vessel overheats.

2. Description of Related Art

Since pressure vessels make it possible to compress and store a large amount of gas in a small volume, it is possible to use a large amount of gas in a small volume. Therefore, they are used in a fixed-type at predetermined positions and installed in vehicles. However, when the pressure vessels are unexpectedly heated by a fire etc., they may break or explode by the abnormal increase in pressure inside the pressure vessels.

Therefore, it is specified by law that a PRD (Pressure Relief Device) should be installed at the gas inlet and outlet to prevent the pressure vessels from being broken by a fire. However, when there is a fire at a portion far from the pressure relief device, such as a partial fire, the pressure vessel may break before the pressure relief device starts operating.

Accordingly, there remains a need in the art for a compressed gas safety discharge system that prevents a pressure vessel from breaking and exploding.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention, in preferred aspects, provides a compressed gas safety discharge system that prevents a pressure vessel from breaking and exploding by appropriately and timely operating a pressure relief device, under any fire circumstances, such as when a fire occurs around the pressure vessel far from the pressure relief device, as well as close to the pressure relief device.

In preferred embodiments, the present invention provides a compressed gas safe discharge system, including a pressure relief device attached to a pressure vessel to suitably discharge in the pressure vessel, using heat applied from the outside; a heater heating pressure relief device; at least one thermal sensing switch suitably disposed around the pressure vessel to switch electric conductivity by heat from the outside; and a power source supplying power for heating the heater by switching of the thermal sensing switch.

According to preferred embodiments, the present invention makes is possible to suitably prevent a pressure vessel from breaking and exploding by appropriately and timely operate a pressure relief device, under any fire circumstances, such as when a fire occurs around the pressure vessel far from the pressure relief device as well as close to the pressure relief device.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a view illustrating a compressed gas safety discharge system according to an embodiment of the present invention.

FIG. 2 is a view showing an example of a pressure relief device and a heater of FIG. 1.

FIG. 3 is a view showing another embodiment of the present invention that includes a pressure relief device 1 employing a glass bulb 23.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE INVENTION

As described herein, the present invention features a compressed gas safe discharge system, comprising a pressure relief device attached to a pressure vessel, a heater heating pressure relief device, at least one thermal sensing switch disposed around the pressure vessel, and a power source.

In one embodiment, the pressure relief device attached to the pressure vessel discharges gas in the pressure vessel using heat applied from the outside.

In another embodiment, the thermal sensing switch switches electric conductivity by heat from the outside.

In still another embodiment, the power source supplies power for heating the heater by switching the thermal sensing switch.

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

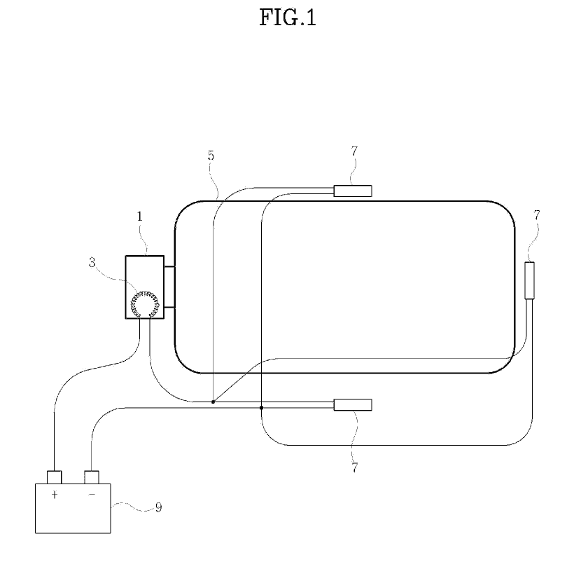

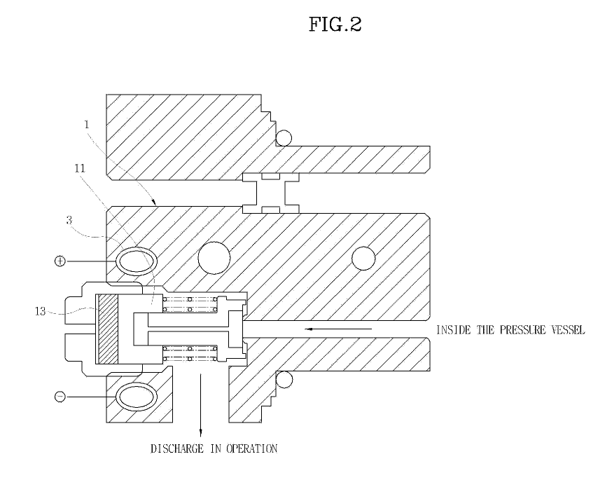

According to certain preferred embodiments and referring to FIGS. 1 and 2 for example, a pressure relief device 1 is suitably attached to a pressure vessel to discharge the gas in the pressure vessel by using heat applied from the outside. Preferably, a heater 3 is provided to heat pressure relief device 1. At least one thermal sensing switch 7 is suitably disposed around the pressure vessel 5 to switch electric conductivity by heat from the outside. Preferably, a power source 9 supplies power for heating heater 3 by switching of thermal sensing switch 7.

According to further exemplary embodiments, a pressure relief device 1 is a common pressure relief device 1 operated by heat in the related art and can be operated by a heater 3 even against a fire where a thermal sensing switch 7 is positioned, as well as where a pressure relief device 1 is positioned. Accordingly, a pressure relief device 1 can appropriately operate against a partial fire around pressure vessel 5.

In a preferred embodiment, thermal sensing switches 7 suitably connect power source 9 with a heater 3 in parallel and are suitably composed of a plurality of bimetal switches electrically connecting power source 9 with heater 3 in heating. Further, the position of thermal sensing switch 7 is a little spaced apart from pressure relief device 1 and, in certain embodiments, is preferentially selected where there is a possibility of a fire, and it is more preferable to distribute them throughout the surface of pressure vessel 1.

According to certain preferred embodiments, a battery can be used as power source 9, for example as shown in the figures, and the battery of vehicles can be used for the vehicles. Preferably, a power source 9 may be any configuration if it can continuously stably supply power even under various circumstances expected in vehicles or devices equipped with pressure vessel 5.

According to certain preferred embodiments, a pressure relief device 1 includes a valve assembly 11 suitably connecting the inside with the outside of a pressure vessel 5 and a soluble member 13 changing in physical property by heat from the outside and allows valve assembly 11 to shift to connect the inside with the outside of a pressure vessel 5, and a heater 3 is suitably provided in a ring shape covering the pressure relief device 1 and soluble member 13.

Accordingly, in a compressed gas safety discharge system having the above configuration, the pressure relief device 1 itself is heated and appropriately discharges the gas inside pressure vessel 5, when a fire occurs around pressure relief device 1. Further, when a fire occurs at a distance from pressure relief device 1 and a critical level of heat is applied to pressure vessel 5, bimetal switches around are operated by the heat and electricity is supplied to heater 3 from power source 9. Consequently, according to preferred exemplary embodiments, the heater 3 generates heat and heats soluble member 13 of pressure relief device 1 to operate valve assembly 11. Accordingly, the compressed gas in the pressure vessel 5 is discharged safely from the pressure vessel 5, before dangerous situations arise, such as breakage of pressure vessel 5, such that safety in using the pressure vessel 5 is considerably improved.

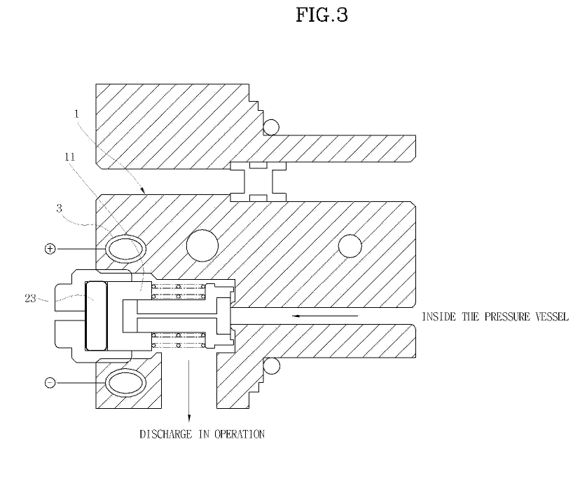

Another embodiment of the present invention is shown in FIG. 3 which includes a pressure relief device 1 employing a glass bulb 23.

In certain exemplary embodiments, if a glass bulb 23 is broken with liquid heated therein, and the liquid is expanded by heat from heater 3, thereafter, compressed gas inside the pressure vessel 5 is suitably discharged through the valve assembly 11, wherein other configurations and operation are the same as described herein.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A compressed gas safe discharge system, comprising:
a pressure relief device attached to a pressure vessel to discharge the gas in the pressure vessel, using heat applied from the outside;
a heater heating pressure relief device;
at least one thermal sensing switch disposed around the pressure vessel to switch electric conductivity by heat from the outside; and
a power source supplying power for heating the heater by switching of the thermal sensing switch.

2. The compressed gas safe discharge system as defined in claim 1, wherein the thermal sensing switches connect the power source with the heater in parallel and are composed of a plurality of bimetal switches electrically connecting the power source with the heater in heating.

3. The compressed gas safety discharge system as defined in claim 2, wherein the pressure relief device includes a valve assembly connecting the inside with the outside of the pressure vessel and a soluble member changing in physical property by heat from the outside and allows the valve assembly to shift to connect the inside with the outside of the pressure vessel, and
the heater is disposed in a ring shape covering the soluble member.

4. The compressed gas safety discharge system as defined in claim 2, wherein the pressure relief device includes a valve assembly connecting the inside with the outside of the pressure vessel and a glass bulb broken by heat from the outside and allows the valve assembly to shift to connect the inside with the outside of the pressure vessel, and
the heater is disposed in a ring shape covering the glass bulb.

5. A compressed gas safe discharge system, comprising:
a pressure relief device attached to a pressure vessel;
a heater heating pressure relief device;
at least one thermal sensing switch disposed around the pressure vessel; and
a power source.

6. The compressed gas safe discharge system of claim 5, wherein the pressure relief device attached to the pressure vessel discharges gas in the pressure vessel using heat applied from the outside.

7. The compressed gas safe discharge system of claim 5, wherein the thermal sensing switch switches electric conductivity by heat from the outside.

8. The compressed gas safe discharge system of claim 5, wherein the power source supplies power for heating the heater by switching the thermal sensing switch.
